(19) United States
(12) Patent Application Publication
(10) Pub. No.: US 2025/0083781 A1
(43) Pub. Date: Mar. 13, 2025

(54) Offshore support structure for a wind turbine and a method of its production with a brace fixed inside a shell-unit attached to a further brace

(71) Applicant: Stiesdal Offshore A/S, Give (DK)

(72) Inventor: Henrik Stiesdal, Odense C (DK)

(21) Appl. No.: 18/941,167

(22) Filed: Nov. 8, 2024

Related U.S. Application Data
(63) Continuation of application No. PCT/DK2023/050112, filed on May 8, 2023.

(30) Foreign Application Priority Data
May 9, 2022 (DK) PA 2022 00440

(51) Int. Cl. B63B 73/40

(52) U.S. Cl. CPC B63B 73/40

(57) ABSTRACT

In an assembly of an offshore support structure for a wind turbine, tubular members are interconnected in grouted connections where a first tubular member has fastened to it a shell-unit comprising a cavity into which an end-part of a second tubular member is inserted and fixed by grouting. The cavity is closed by a rigid entrance-flange that is fastened to the walls of the shell-unit. The design converts forces acting on the second tubular member to compression forces acting on the grout in the cavity.

### CROSS-REFERENCE TO RELATED APPLICATIONS

This application is a continuation under 35 U.S.C. 111 of International Patent Application No. PCT/DK2023/050112, filed May 8, 2023, which claims the benefit of and priority to Danish Application No. PA 2022 00440, filed May 9, 2022, each of which is hereby incorporated by reference in its entirety.

### FIELD OF INVENTION

The present invention relates to methods of assembly and optionally also installation of an offshore support structure for a wind turbine, as well as to offshore support structures made by the methods.

### BACKGROUND

For offshore support structures, for example for supporting wind turbines, tetrahedral structures are advantageous in that they exhibit a high degree of stability, while on a relative scale requiring only moderate costs. Examples of such structures are disclosed in international patent application WO2017/157399.

Different principles for connecting struts of support structure are disclosed in the prior art. For example, WO2022/008021A1 discloses tetrahedral offshore platforms for wind turbines where ends of connecting braces are inserted through openings into larger braces and a grout cast is filling a portion of the larger brace. Japanese patent application JP2000-87504A and international patent application WO2013/156110 disclose two different and mutually alternative approaches. In WO2013/156110, the metal strut is provided with a metal shell welded to its end, where the metal shell is fastened, for example glued, to an outer side of the connecting metal tube. JP2000-87504A discloses a method for providing an offshore tower structure where ends of connecting tubes are inserted through openings into larger braces, and a grout cast is filling a portion of the larger brace and an end-part of the tube. In order for the grout to be held inside the cavity, a flexible sleeve made of rubber seal material is provided in the gap between the opening of the main member and the sub member inserted therein. Seals, in particular made of elastomers, for closing volumes of grout are also disclosed in US2012/263545, JP2012-077533, and U.S. Pat. No. 5,385,432.

U.S. Pat. No. 5,385,432, JP2012-77533 and JP2000-87504 disclose use of shear keys on the grout cavity or on tubular elements inserted into a grout cavity for achieving axial stability. Although shear keys increase the stability of the connection, a steady shift of load on the nodes due to constant moves by waves, causes wear on the connection despite the shear keys.

Accordingly, there is a need for further improvements of stability in such grouted nodes.

### BRIEF DESCRIPTION

An improved construction method for offshore platforms for wind turbines, especially for tubular structures, optionally tetrahedral structures, is disclosed herein. Furthermore, it is an objective to provide a construction method for offshore platforms, especially for wind turbines, in which grouted connections are provided at ends of tubular segments and which in a relatively simple way increases the stability of grouted connections. One or more of these objectives as well as further advantages are achieved by a method of assembling and optionally also installing an offshore support structure for a wind turbine as described below.

In short, in an assembly of an offshore support structure for a wind turbine, tubular members are interlinked at rigid connection nodes to form a three-dimensional grid. Part or all of the connection nodes are established as grouted connections where a first tubular member has a shell-unit forming a cavity into which an end-part of a second tubular member is inserted and fixed by grouting, and where the forces and moments applied to the first tubular member by the second tubular member are mainly transferred by compression in the grout. As alternatives to grout, the casting can be done by other hardening fixation materials.

The shell-unit of the first tubular member is provided with a cavity for receiving an end-part of the second tubular member in the cavity for forming a rigid connection node. The cavity has a cavity-entrance and a cavity-bottom and cavity-walls extending from the cavity-entrance to the cavity-bottom. The shell-unit is rigidly attached to the main part of the first tubular member by any relevant method applied to join individual members. For steel members the joint may be established by welding, and for concrete members the joint may be established by a combination of concrete and rebars. Also, gluing is an option. The shell-unit may be located entirely on the outside of the first tubular member, or it may partly or completely penetrate into the internal area of the first tubular member.

For example, once correctly inserted into in the shell-unit and fixed therein, the longitudinal axis of the second tubular member is extending at an angle in the range of 10-90 degrees from the longitudinal axis of the first tubular member.

The cavity in the shell-unit has a cavity opening towards a first end of the shell-unit, which is an outer end remote from the first tubular member, for insertion of the second tubular member through the cavity opening into the cavity, and the cavity is closed towards a second end of the shell-unit for preventing the grout or other fixation material escaping from the cavity. After insertion of the second tubular member into the cavity, the cavity opening at the first end of the shell-unit is closed towards the outside by a rigid entrance-flange that is fastened to the shell-unit. The entrance-flange is a ring-flange extending as a collar around the first tubular member, once inserted into the cavity.

The closure at the second end of the cavity may be established with a bulkhead or with some other means of establishing a closed cavity. Part of the closure may be of a temporary nature, being established during installation to allow the filling of the cavity with grout without spillage and to be partially opened afterwards.

The end-part inside the cavity has a widened portion, typically at the end. The term widening has to be understood as related to the lateral cross-section at the cavity entrance and is explained in more detail in the following with reference to some concrete examples. The widened portion has a lateral cross-section that extends outside the lateral cross-section, typically circular cross-section, of the second tubular member at the cavity entrance. The lateral cross-section is perpendicular to the longitudinal axis of the second tubular member. For example, the end-part of the second tubular member has a widened portion, such as an end-flange, with a diameter that is larger than the diameter of the second tubular member at the cavity-entrance. In other words, inside the cavity, a portion of the end-part extends radially outwards as compared to the lateral cross-section at the cavity entrance.

The end-flange, however, need not be arranged laterally to the longitudinal axis of the second tubular member. Therefore, for a more general definition for a criterion of the widened portion, offset is taken in a lateral cross-section of the second tubular member at the cavity entrance. This cross-section has outer cross-sectional boundaries. For example, for the second tubular member being a cylinder with circular cross-section, the outer boundaries follow a circle. The end-part inside the cavity is provided with a widened portion, for example an end-flange, which, when projected onto the cross-sectional plane at the cavity entrance, extends beyond the lateral cross-section of the end-part at the cavity-entrance. Thus, the projection of the widened portion is at least partially outside the cross-sectional boundaries of the second tubular member at the cavity entrance.

Optionally, the width of the end part increases from the cavity entrance to the widened portion by 2-40%. In particular, with reference to the projection described above, the extension of the projection of the widened portion onto the cross-sectional plane at the cavity entrance is 2-40% larger than the lateral cross-section of the end-part at the cavity-entrance. In this case, for circular cross-sections, the diameter of the end-part increases 2-40% relative to the diameter of the second tubular member at the cavity-entrance. The larger diameter may be established with a flange, with a conically widening portion, or with any other components by which extension of the cross-section, for example diameter, is increased.

After the end-part of the second tubular member has been inserted through the cavity-entrance into the cavity inside the shell-unit, the cavity is closed by an entrance-flange that extends as a ring around the second tubular member and is fastened to the shell-unit. The entrance-flange is made of a rigid material, typically steel or concrete, and fastened rigidly to the shell-unit after the cavity has been closed with the entrance-flange.

In some practical embodiments, for placing the entrance-flange around the second tubular member, the entrance-flange is provided in two or more flange pieces that are positioned on opposite sides of the second tubular member and combined into a single entrance-flange around the second tubular member.

Advantageously, a seal, for example an elastomer gasket, is sealing between the flange-opening in the entrance-flange and the second tubular member. Another seal, for example an elastomer gasket, may be sealing between the entrance-flange and the first end of the shell-unit.

After the cavity has been closed, a layer of grout or other hardening casting material is provided in the cavity of the shell-unit, for example by pumping it into the cavity.

Advantageously, the fixation material is fluidic or semi-fluidic, for example polymer or grout, which is then hardened to provide the solidified rigid casting. Grout is an exemplary material due to its high rigidity and longevity in saltwater. In the following, grout is exemplified as the casting material, but it could be substituted by another casting material, if it is more appropriate or useful.

Advantageously, the end-part of the second tubular member is inserted into the cavity until a distance from the closed bottom, and the cavity is filled with grout or other fixation material in a space of the cavity between the closed bottom and the end-part, maintaining the distance during and after hardening. This results in the grout taking up pushing and bending forces and transferring forces to the walls of the cavity and, thus, to the shell-unit.

By providing the end-part of the second tubular member with a closed end, flow of grout or other fixation material is prevented from entering an interior of the second tubular member, which minimizes consumption thereof.

By hardening the grout, the end-part of the second tubular member is fixed rigidly inside the cavity.

Longitudinal forces acting on the second tubular member are mainly transferred to the first tubular member by compression of the grout. Tensile forces acting on the second tubular member are mainly transferred as compression of the grout between the widened portion and the entrance-flange at the first end of the shell-unit. Compressive forces acting on the second tubular member are mainly transferred as compression of the grout between the widened portion and the closure at the second end of the shell-unit. Transverse forces acting on the second tubular member are mainly transferred as compression of the grout between the outside of the end-part and the inside of the wall in the shell-unit. Bending moments acting on the second tubular member are mainly transferred as force-pairs established by compression on one side of the grout between the widened portion and the entrance-flange at the first end of the shell-unit, and compression on the opposite side of the grout between the widened portion and the closure at the second end of the shell-unit. In all cases, shear forces between the second tubular member and the shell-unit on the first tubular member may contribute to the load transfer, but primarily, loads are transferred through compression of the grout.

Since the allowable compression stress of grout may be a factor of 10 or more higher than the allowable shear stress of grout, when taking safety and stability criteria into regard, the transfer of forces mainly as compression in the grout, rather than mainly as shear in the grout as is known from conventional grouted connections, allows better utilization of the grout. As a consequence, it is possible to establish a connection relying on smaller surfaces for the load transfer and using less grout than in conventional grouted connections.

The tight enclosure of the grout or other fixation material in the cavity by the entrance-flange prevents deterioration of the grout. Particularly when using elastomeric seals between the flange-opening in the entrance-flange and the second tubular member and between the entrance-flange and the first end of the shell-unit, water ingress into the grouted joint is minimized, and washing-out of the grout is prevented. As a consequence, the integrity of the grouted joint will be maintained even in case of grout damage or crumbling.

This is in contrast to cylindrical end-parts in cavities of the prior art, which are not covered by a rigid entrance-flange, and wherein a grouted connection, even with sheer keys, cannot guarantee a rigid connection over time. The present systems and methods provide a simple solution to a severe problem that occurs under long term use, where grout cracks and breaks inside the cavity. The additional rigidity obtained by the systems and methods prolongs the stability and usability of such offshore support platforms.

It is important to emphasize that the systems and methods are based on securing the braces against forces by converting the forces into compression of the grout and transfer of forces from the grout to the shell-unit. This results in a higher strength than in the prior art, even if the connection nodes are free from shear keys.

As it appears from the above, the rigid entrance-flange being fastened rigidly to the shell-unit transfers forces from the subsequently hardened casting material to the shell-unit. It is also preventing movement of the end-part out of the cavity by pulling forces acting on the second tubular member along its longitudinal axis.

For example, for the assembly, a first set of a number of N, for example N=3, 4, 5 or 6, first tubular braces and a second set of N second tubular braces are provided in addition to a tower support that is used to carry a wind turbine tower. These components are then assembled into a support structure.

Although, the assembly method is particularly useful for an offshore support structure with an offshore wind turbine, the generality of the method does not exclude that it is used as a support structure for an offshore platform of other types, for example a floating platform of a more general type.

In some embodiments, for each pair of one of the first braces and one of the second braces, the second end-part of the first brace is connected to a first part of the tower support at a first node connection, and the second end-part of the second tubular brace is connected to a second part of the tower support at a second node connection. Further, the first end-part of the second brace is connected to the first brace at a third node connection. The second node connection is above the first node connection when the support structure is oriented for operation, where the wind turbine tower is in vertical orientation. Accordingly, the tower support, the first brace, and the second brace form a triangle in a vertical plane. Due to the vertical triangular shape of the combination of the tower support, the radial brace, and the second brace, the second brace is also called a diagonal brace. The N pairs of braces are directed outwards from the tower support in different directions about a vertical central axis of the tower support, optionally in a horizontal plane. For this reason, the first braces are also called radial braces.

For a seabed-fixed support structure, the rigid frame structure with tower support and N first braces and N second braces is typically sufficient for long term stability. For floating structures, such as Tension Leg Platforms (TLP) for wind turbine towers or semisubmersible platforms, it is desirable to provide additional stability. For this reason, as an option, the following extended embodiment is useful.

In this extended embodiment, a third set of N third braces, typically tubular braces, are provided for interconnecting the first braces by the third braces. The above-described method with shell-units as connectors is advantageously also used for the third braces, although, in principle, the third braces could also be connected to the first braces by welding or by connection to corresponding brackets.

For example, for N=4, the first braces form a cross with the tower support in the center, and the third braces stabilize the cross in the plane formed by the cross. Typically, the third set of N=4 braces form a square in which the first braces form the diagonals. The first and third braces are optionally in a single plane. However, this is not strictly necessary. For example, the third braces form a square in one plane, and the first braces extend with their first end in the tower support out of such plane, for example below the plane of the square of the third braces. Furthermore, it is also not strictly necessary that the braces are equally long, and one or two of the first braces may be longer than the remaining two in order for the assembly of the N=4 third braces to deviate from a square and form a rectangle, instead.

Another, typical example is for N=3, in which the third braces form a triangle, optionally with the tower in the center of the triangle. These third braces are also called side braces, as they form sides of a triangle. The first braces are also typically called radial braces, as they extend radially from the tower support to one of each of the corners in the triangle. Also, in this case, the first and third braces are optionally in a single horizontal plane. However, this is not strictly necessary. For example, the third braces form a triangle in one plane, and the first braces extend with their first end in the tower support out of such plane, for example below or above the horizontal plane of the triangle of the third braces. Furthermore, it is also not strictly necessary that the braces are equally long, forming an equilateral triangle, as the triangle need not necessarily be regular. Even further, it is possible that the tower support is not in the center of the triangle. For example, the tower support is provided on or near to one of the sides of the triangle.

Optionally, the interconnection of the first braces by the third braces involves interconnecting the ends of the first braces by the third braces. However, this is not strictly necessary, as the connection can be a distance offset from the ends.

For the case N=3, the assembly may result in a tetrahedral structure formed by the first, second and third braces, optionally formed as a regular tetrahedron. In this case, the first braces are radial braces that extend radially from the tower support. The third braces are side braces, as they form sides of a triangle. The second braces are diagonal braces, as they extend diagonally from the first braces to the tower support, each second brace forming a vertical triangle with the first brace and the tower support.

For example, the columns support is centered in the tetrahedral structure. Alternatively, it is off-centered, or the tower support is provided in a corner of the super structure or along a side of a triangle between two nodes.

Once, the offshore support structure has been assembled, typically onshore or on land, a wind turbine is mounted on top of the structure. The assembly is then moved to a point of destination offshore, typically dragged along by vessels, and then anchored to the seabed, for example while maintaining the structure floating. As mentioned, examples are TLP, which typically are floating under water, and semi-submersibles, which are floating half submersed in the water at the surface.

The first and second braces are tubular, and typically also the third braces are tubular. Optionally, the tubular braces have volumes with positive buoyancy. Optionally, the volumes can be flooded for adjusting the buoyancy. In most general cases, the braces are straight.

As an example, braces optionally have a diameter in the range of 1 to 6 meters, the larger of which can be more than 50 meters long. Brace ends are optionally inserted a distance of 3 to 5 meters in the respective cavity.

Optionally, the tower support itself is tubular, for example cylindrical or conical or a combination thereof in adjacent sections of the tubular support structure.

### BRIEF DESCRIPTION OF THE DRAWINGS

The systems and methods will be explained in more detail with reference to the drawings, where

FIG. 1 shows a tetrahedral structure, according to an embodiment, for an offshore wind turbine;

FIG. 2 illustrates a principle of a grout connection, according to an embodiment;

FIG. 3 is a sketch of a side view of a grout connection, according to an embodiment;

FIG. 4A illustrates a perspective view of an entrance-flange with a bayonet-type lock, according to an embodiment;

FIG. 4B illustrates a head-on view of the entrance-flange of FIG. 4A;

FIG. 5 is a sketch of a side view of a grout connection with a conical end-part, according to an embodiment;

FIG. 6 illustrates a shell that extends through an opening into the first tubular member, according to an embodiment; and

FIG. 7 illustrates a modified embodiment relatively to the embodiment in FIG. 5.

### DETAILED DESCRIPTION

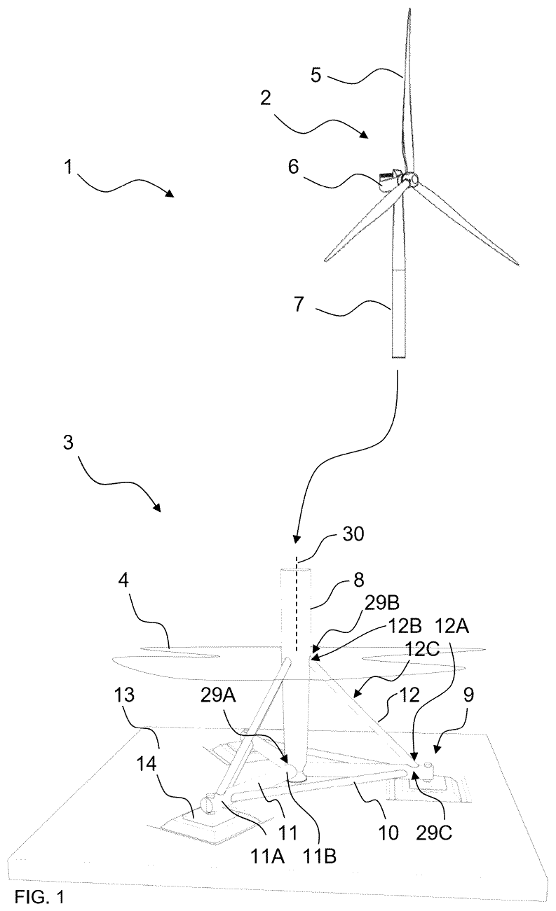

FIG. 1 illustrates an offshore wind turbine installation 1. The installation 1 comprises a wind turbine 2 and an offshore support structure 3 on which the wind turbine 2 is mounted for operation and by which it is supported in offshore conditions. The wind turbine 2 comprises a rotor 5 and a tower 7 and nacelle 6 that connects the rotor 5 with the tower 7. Notice that the wind turbine 2 is not to scale with the support structure 3 but is shown at smaller scale for ease of illustration.

The offshore support structure 3 is exemplified as a bottom supported structure with feet 14 embedded in the seabed 13 under the water surface 4. Such type of offshore support structure 3 is used in shallow waters. Typically, for deeper waters, floating structures are used, for example semisubmersible structures with mooring lines and buoyancy tanks that keep the structure 3 floating half-way submersed under water. In such case, the buoyancy tanks would be mounted at the nodes 9 of the structure 3 instead of the feet 14, unless the tubular structure itself provides sufficient buoyancy. Alternatively, the structure 3 could be a tension leg platform (TLP) with a fully submerged floating support structure. A floating support structure 3 would be held in its location by mooring lines that are fixed to the seabed 13.

The exemplified structure 3 has a tetrahedral shape with a central tower support 8. From a first, lower part of the tower support 8, first braces 11 extend generally radially outwards into different radial directions with 120 degrees in between, so that these first braces 11 are also called radial braces 11, a term that will be used in the following for simplicity. From a second, upper part of the tower support 8, second braces 12 extend to the radial braces 11 so that the tower support 8 together with each set of one radial brace 11 and one second brace 12 forms a planar vertically oriented triangle. The second brace 12 is also called diagonal brace 12 due to the triangular shape of the combination of the tower support 8, the radial brace 11, and the diagonal brace 12, a term that will be used in the following for simplicity. A triangular base for the tetrahedron is formed by each set of a side brace 10 and two radial braces 11. The side braces 10 are interconnecting the radial braces 11 for increased stability.

Each of the radial braces 11 connects with its second end-part 11B to a first, lower part of the tower support 8 at first rigid connection node 29A, and each of the diagonal braces 12 connects with its second end-part 12B to a second, upper part of the tower support 8 at second rigid connection nodes 29B. The first end-part 12A of each of the diagonal braces 12 connects to one of the radial braces 11 at a third rigid connection node 29C, typically at a location at or near the first end-part 11A of the corresponding radial brace 11.

The tower support 8 is exemplified as a support column but could have other shapes than illustrated. As illustrated, the tower support 8 extends to a position above the water surface 4, which is also characteristic for floating support structures.

As will be exemplified later in more detail, the connections between the braces 10, 11, 12 and the tower support 8 are casted connections, for example grouted connections, where an end-part 11A, 11B, 12B of a brace 11, 12 is accommodated in a cavity of another brace and/or in a cavity of the tower support 8, which is then filled with a fixating casting material, typically grout, which is then hardened to provide a solidly fixed connection.

Examples of casted connections between the diagonal brace 12 and the radial brace 11 are described in more detail with reference to the corresponding illustrations in the following. However, similar connections can be used for fixing the second end-parts 11B, 12B of the braces 11, 12 to the tower support 8.

Although, the system has been exemplified for a triangular, especially, tetrahedral structure, it is also applicable for other polygonal structures, for example having 4, 5 or 6 radial braces 11 and a corresponding number of diagonal braces 12. As a typical option, in order to end with a structure as illustrated in FIG. 1, side braces 10 are connected to the radial braces 11, which enhances rigidity.

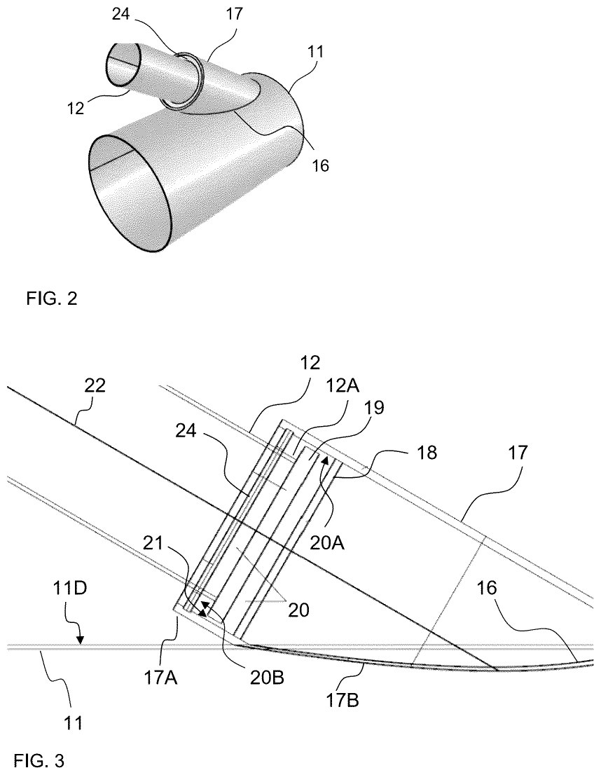

FIG. 2 is a perspective drawing of a coaxial arrangement where a first end-part of a tubular diagonal brace 12 is inserted into a cavity in a shell-unit 17 that is welded onto the tubular radial brace 11 along a welding seam 16. The cavity does not extend into the radial brace 11. After insertion of the end-part of the diagonal brace 12 into the shell-unit 17, grout or other hardening fixation material is injected into the cavity space between the end-part of the diagonal brace 12 and the inner walls of the shell-unit 17. Prior to injection of the fixation material, the cavity space is closed by an entrance-flange 24 extending around the diagonal brace 12, optionally with an elastomer gasket, preventing the fixation material from escaping the cavity in the shell-unit 17. Providing a minor injection opening is sufficient for filling the fixation material into the cavity. The entrance-flange 24 or the elastomer gasket can be provided with such injection opening.

In some practical embodiments, for placing the entrance-flange 24 around the second tubular member, the entrance-flange 24 is provided in two or more flange pieces that are positioned on opposite sides of the second tubular member 12 and combined into a single entrance-flange 24 around the second tubular member 12.

The entrance-flange 24 is fastened to the shell-unit 17 so that axial pulling forces acting on the radial brace 12 are transferred to the entrance-flange 24 and further to the shell-unit 17. Furthermore, as will be explained in more detail below, the grout or other casting material is primarily subject to compression forces inside the cavity in a situation of load between the braces 11, 12. The entrance-flange 24 provides an additional stability for the diagonal brace 12 in the tubular shell-unit 17.

Notice that a similar arrangement and connection can be made between the tower support 8 and a diagonal brace 12 and/or between the tower support 8 and a radial brace. A similar arrangement can also be made between a radial brace 11 and a lateral brace 10, or between any type of brace and a buoyancy tank of a floating offshore foundation.

FIG. 3 illustrates a sketch in a cross-sectional side view of the diagonal brace 12 with its end-part 12A inserted through the first end 17A of the shell-unit 17 into a cavity 20 of the shell-unit 17. The shell-unit 17 is made of steel and fastened with its second end 17B by a weld 16 to the surface of the radial brace 11, which is also made of steel.

In the exemplified embodiment of FIG. 3, the shell-unit 17 extends only outwards from the radial brace 11 and not inwards into an inner volume of the radial brace 11. This has some advantages in that the radial brace 11 need not have a hole for a cavity, and the cavity 20 is solely provided in the shell-unit 17 on the surface of the radial brace 11.

For delimiting the amount of grout or other fixation material for the connection, the cavity 20 is closed by an end wall 18 at its bottom. Without this end wall 18, grout would fill the entire inner volume of the shell-unit 17, but would not enter the radial brace 11, as the shell-unit 17 is only provided on the outer side of the radial brace 11, without the radial brace 11 having an opening within the surface region delimited by the weld seam 16.

After insertion of the first end-part 12A of the diagonal brace 12 through the cavity entrance 20B into the cavity 20 inside the shell-unit 17, the cavity 20 is closed by an entrance-flange 24 which is fastened to the shell-unit 17, for example by a bayonet connection or a bolted connection.

After closing of the cavity 20, casting material, typically grout, is inserted into the volume of the cavity 20 between the inner wall 20A of the shell-unit 17 and the outer wall of the first end-part 12A of the diagonal brace 12, after which the casting material is solidified for rigidly fixing the diagonal brace 12 in the shell-unit 17.

The end-part 12A of the diagonal brace 12 is closed by a closed end-flange 19 that has a larger diameter than the diameter of the end-part 12A of the diagonal brace 12 at the cavity entrance 20B. As illustrated, the end-flange 19 also has a larger diameter than the diameter of the opening through the entrance-flange 24.

In the following, the action of the forces is explained with respect to grout, although also other casting material can be used.

Tensile forces acting on the diagonal brace 12 are transferred to the shell-unit 17 and thereby to the radial brace 11 mainly by compression of the grout between the end-flange 19 and the entrance-flange 24. Compressive forces acting on the diagonal brace 12 are mainly transferred by compression of the grout between the end-flange 19 and the end-wall 18. Transverse forces acting on the diagonal brace 12 are mainly transferred as compression of the grout between the combined area of the outside of the end-part 12A of the diagonal brace 12 and the end-flange 19, and the inside 20A of the shell-unit 17 forming the cavity 20. Bending moments acting on the diagonal brace 12 are mainly transferred as force-pairs established by compression of the grout on one side between the end-flange 19 and the entrance-flange 24, and compression of the grout on the other side between the end-flange 19 and the end-wall 18. In all cases, shear forces between the end-part 12A of the diagonal brace 12, the end-flange 19, and the inside 20A of the shell-unit 17 forming the cavity 20 may contribute to the load transfer, but primarily, loads are transferred through compression of the grout.

It is important to understand that this way of transferring forces and moments differs from the prior art. In conventional grouted connections, the forces are transmitted by shear. Shear strength has been attempted to be improved by adding shear keys. However, forces are transferred internally in the grout as shear. In contrast thereto, by the present system, the forces are transmitted by compression. The joint would function even if the surfaces were provided with a low friction surface, such as a greasy surface. It is put forward that strength of grout is far greater in compression than in friction, even when using shear keys. Unreinforced grout can transfer up to 60-80 MPa in compression, while it is usually assumed not to transfer more than 1-2 MPa in shear as is known from prior art systems. Therefore, by using compression of the grout, a more compact assembly can be made, while still having larger strength than in prior art grout connections, even when these include shear keys. For these reasons, also, the grouted connections described herein do not need shear keys and are typically provided without shear keys.

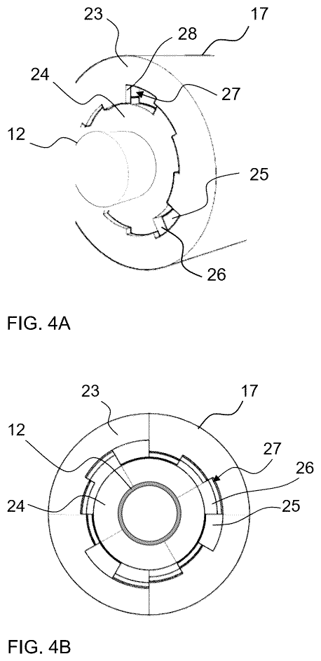

FIGS. 4A and 4B illustrate a bayonet fastening principle for the entrance-flange 24, through which the diagonal brace 12 extends. FIG. 4A illustrates a perspective view and FIG. 4B a head-on view from inside the cavity 20 towards the radial brace 12. The fastening principle resembles a bayonet lock. The shell-unit 17 comprises at its entrance an entrance plate 23 that has a central opening extending radially into three open slots 25 offset by 120 degrees between each other. Correspondingly, the entrance-flange 24 comprises three radially extending protrusions 26, correspondingly offset by 120 degrees between each other, which fit into the slots 25. Once, the protrusions 26 are inserted into the slots 25, the depth of which is deeper than the thickness of the entrance-flange 24, axial rotation of the entrance-flange 24 results in the protrusions 26 being moved behind the edges 28 of the entrance plate 23 so that the entrance-flange 24 is locked to the entrance plate 23 of the shell-unit 17. A minor radial clearance 27 is advantageous for ease of rotation. It is pointed out that a different number of slots and protrusions can be used than three.

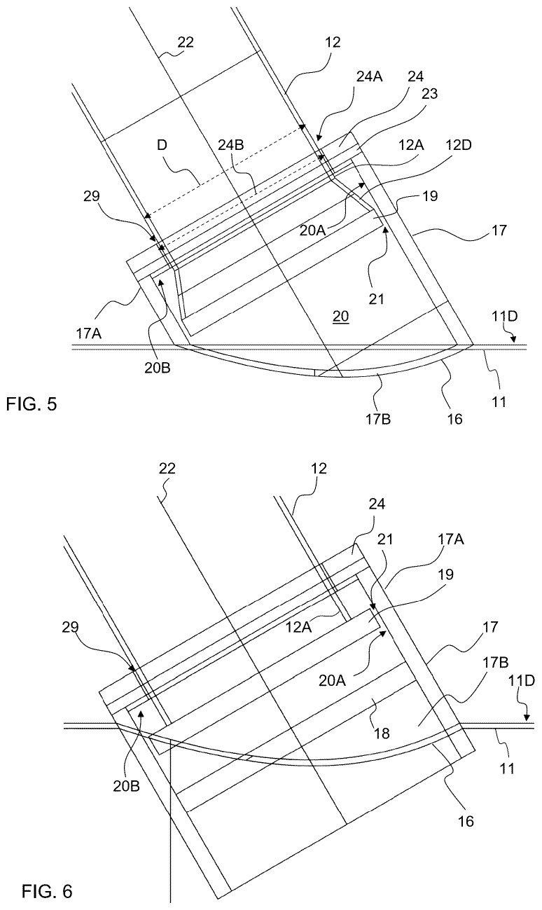

FIG. 5 illustrates another embodiment of the joint in a cross-sectional side view of the diagonal brace 12 with its end-part 12A inserted into a cavity 20 of the shell-unit 17. The shell-unit 17 is made of steel and fastened with its second end 17B by a weld seam 16 to the surface 11D of the radial brace 11, which is also made of steel.

In the exemplified embodiment of FIG. 5, the end-part 12A of the diagonal brace 12 has a conical shaped portion 12D inside the cavity 20 providing a larger diameter of the end-part 12A of the diagonal brace 12 inside the cavity 20 than the diameter D of the diagonal brace 12 at the entrance 20B of the cavity 20 and larger than the diameter 24B of the throughput-opening 24A in the entrance-flange 24. The end-part 12A of the diagonal brace 12 is closed by a closed end-flange 19 in order to prevent grout from entering into an inner volume of the diagonal brace 12. Unlike the embodiment shown in FIG. 3, no end-wall 18 is provided, and the cavity 20 is delimited by the surface 11D of the wall of the radial brace 11. Thus, when grout is filled into the cavity 20, the grout extends to the surface 11D of the radial brace 11, delimited by the welding seam 16.

After insertion of the first end-part 12A of the diagonal brace 12 through the cavity entrance 20B into the cavity 20 inside the shell-unit 17, the cavity 20 is closed by the entrance-flange 24, which is fastened to the shell-unit 17 by a bolted connection. For ease of connection, the shell-unit 17 is provided with an entrance-plate 23, typically welded to the first end 17A of the shell-unit 17, and the entrance-flange 24 is fastened to the entrance plate 23 by bolts (not shown). However, other fastening means are possible than bolts.

After closing of the cavity 20, casting material, typically grout, is inserted into the volume of the cavity 20 between the inner wall 20A of the shell-unit 17 and the outer wall of the first end-part 12A of the diagonal brace 12, after which the casting material is solidified for rigidly fixing the diagonal brace 12 in the shell-unit 17.

As illustrated, there is a small clearance 29 between the diagonal brace 12 and the entrance-flange 24. This clearance is typically closed by a gasket extending around the diagonal brace 12 at the location of the entrance-flange 24.

Tensile forces acting on the diagonal brace 12 are mainly transferred to the shell-unit 17 and thereby to the radial brace 11 by compression of the grout between the end-part 12A, the entrance-flange 24, and the inside of the shell-unit 17 in the part between the entrance-flange 24 and the end-flange 19. Compressive forces acting on the diagonal brace 12 are mainly transferred by compression of the grout between the end-flange 19 and the outside of the radial brace 11. Transverse forces acting on the diagonal brace 12 are mainly transferred as compression of the grout between the combined area of the outside of the end-part 12A of the diagonal brace 12 and the end-flange 19, and the inner side 20A of the shell-unit 17 forming the cavity 20. Bending moments acting on the diagonal brace 12 are mainly transferred as force-pairs established by compression on one side of the grout between the end-flange 19 and the entrance-flange 24, and compression on the other side of the grout between the end-flange 19 and the outer side 11D of the radial brace 11. In all cases, shear forces between the end-part 12A of the diagonal brace 11, the end-flange 19, and the inside of the shell-unit 17 forming the cavity 20 may contribute to the load transfer, but primarily, loads are transferred through compression of the grout.

Advantageously, the extension of the end-flange 19 in the radial direction perpendicular to the central axis 22 of the diagonal brace 12 is less than the cavity cross-section so that there is provided a clearance space 21 between the edge of the end-flange 19 and the inner walls 20A of the shell-unit 17. The clearance space 21 results in the end-part 12A including its end-flange 19 being fully embedded in the grout or other hardened fixation material. Forces acting on the grout or other hardened fixation material are thus distributed into other directions, distributing the load into more than one direction.

FIG. 6 illustrates another embodiment of the joint in a side view. The end-part 12A of the diagonal brace 12 is inserted through the cavity entrance 20B into a cavity 20 of the shell-unit 17. The shell-unit 17 is made of steel and penetrates through the wall of the radial brace 11 into the inner volume of the radial brace 11, which is also made of steel. The shell-unit 17 is fastened to the outer side 11D of the wall of the radial brace 11 with a welding seam 16. Penetration of the wall of the radial brace 11 reduces the extent to which the shell-unit 17 extends outside the periphery of the radial brace 11, which may have transportation advantages, without compromising mechanical stability. The functionality of the joint illustrated in FIG. 6 is otherwise similar to the functionality of the joint illustrated in FIG. 5.

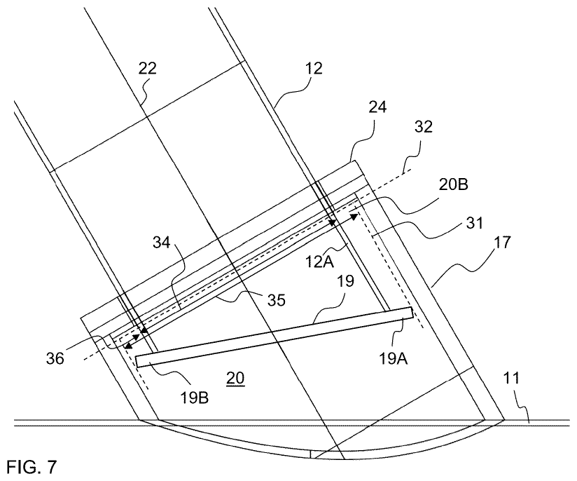

FIG. 7 illustrates a modified version of FIG. 5, where the flange 19 has been inclined at a different angle than the perpendicular version in FIGS. 4A and 4B. Due to the similarity with FIGS. 4A and 4B, some of the reference numbers have been omitted for sake of clarity, although they apply equally. The above-explained grout-compression effect is also achieved in this embodiment. For further clarification, the following is pointed out. The end-part 12A of the diagonal brace 12 has a first cross-section 34 in a cross-sectional plane 32 that is oriented perpendicular to the longitudinal axis 22 and located at the cavity entrance 20B. This first cross-section 34 is made up of an inner circle and an outer circle because the diagonal brace 12 has a circular-cylindrical wall. The outer circle of the first cross-section 34 provides an outer cross-sectional boundary 36 of this first cross-section 34. The flange 19 is a widened portion of the end-part 12A, the projection of which onto the cross-sectional plane 32 (see illustration lines 31 and arrow 35) extends outside the cross-sectional boundaries 36 of first cross-section 34 of the diagonal brace 12 at the cavity entrance 20B. Due to this lateral extension of the projection 31, 35 of the flange 19 beyond the first cross-section 34 at the cavity entrance 20B, similar arguments apply with respect to compression of the grout and transfer of forces from the flange 19 to the grout and from the grout via the entrance flange 24 to the shell-unit 17, when forces are acting on the diagonal brace 12.

It is pointed out that the grouted connections in the above figures have been exemplified as connections between a diagonal brace 12 and a radial brace 11. However, the same principle applies for connections between a tower support 8 having a shell-unit 17 with a cavity and a second end-part 12B, 11B of a diagonal brace 12 or a radial brace 11 inserted into such cavity. It also applies for connections between a radial brace 11 and a tower support 8, for connections between a radial brace 11 and a lateral brace 10, for connections between any type of brace and a buoyancy tank of a floating offshore support structure for a wind turbine, or for any other type of joint relevant to a bottom-fixed or floating offshore support structure for a wind turbine.

What is claimed is:

1. A method for constructing an offshore support structure for supporting a wind turbine, the method comprising:
interlinking tubular members at rigid connection nodes to form a three-dimensional grid;
providing a first and a second of the tubular members, wherein the first tubular member has opposite ends and a tubular wall with an inner side and an opposite outer side between the opposite ends, wherein the first tubular member is provided with a cavity for receiving an end-part of the second tubular member in the cavity for forming one of the rigid connection nodes, wherein the cavity has a cavity-entrance and a closed cavity-bottom and cavity-walls extending from the cavity-entrance to the cavity-bottom;
inserting the end-part of the second tubular member through the cavity-entrance into the cavity;
closing the cavity;
providing a layer of hardening casting material in the closed cavity between the end-part and the cavity-walls and the closed cavity-bottom;
by hardening the casting material, fixing the end-part of the second tubular member rigidly inside the cavity, wherein the second tubular member has a longitudinal axis and a first lateral cross-section at the cavity entrance with an outer cross-sectional boundary in a cross-sectional plane oriented perpendicular to the longitudinal axis, wherein the end-part inside the cavity is provided with a widened portion, for which a projection onto the cross-sectional plane extends beyond the first lateral cross-section outside the cross-sectional boundaries;
providing the cavity as part of a shell-unit that is rigidly attached to the first tubular member;
providing an entrance-flange of a rigid material and with a flange-opening;
arranging the entrance-flange with the flange-opening around the second tubular member;
prior to insertion of the casting material into the cavity, closing the cavity by the entrance-flange; and
fastening the rigid entrance-flange rigidly to the shell-unit for transfer of forces from the subsequently hardened casting material via the entrance-flange to the shell-unit and for preventing movement of the end-part out of the cavity by pulling forces along the longitudinal axis.

2. The method according to claim 1, further comprising:
inserting the end-part of the second tubular member into the cavity until a distance from the closed bottom;
filling the cavity with the casting material in a space of the cavity between the closed bottom and the end-part; and
maintaining the distance during and after hardening.

3. The method according to claim 1, further comprising:
inserting the end-part of the second tubular member into the cavity with the widened portion being positioned with a spacing to the wall of the cavity for preventing the widened portion from contacting the wall;
maintaining the spacing between the widened portion and the wall of the cavity by filling the spacing with the casting material.

4. The method according to claim 1, further comprising providing the widened portion as a circular end-flange having a diameter larger than the second tubular member at the cavity entrance.

5. The method according to claim 1, further comprising providing an elastomeric gasket on the entrance-flange for sealing the flange-opening against the second tubular member.

6. The method according to claim 1, further comprising providing the shell-unit fastened to the first tubular member by welding along a welding seam on the first tubular member.

7. The method according to claim 6, further comprising providing the welding seam as a closed curve surrounding an area on the outer side of the first tubular member, wherein the first tubular member is unbroken in the area surrounded by the welding seam.

8. The method according to claim 1, further comprising fixing the second tubular member with its longitudinal axis at an angle in a range of 10-90 degrees from a longitudinal axis of the first tubular member.

9. The method according to claim 1, the method further comprising:
providing a tower support for carrying a wind turbine tower;
providing N first braces and N second braces, wherein N is an integer of at least three, each brace having a first end-part and a second end-part; and
for each pair of one of the first braces and one of the second braces, connecting the second end-part of the first brace to a first part of the tower support at a first rigid connection, and connecting the second end-part of the second tubular brace to a second part of the tower support at a second rigid connection, and connecting the first end-part of the second brace to the first brace at a third rigid connection, wherein the second part of the tower support and the second rigid connection are above the first part of the tower support and the first rigid connection when the support structure is oriented for offshore operation, and wherein the tower support, the first brace, and the second brace in combination form a triangle in a vertical plane, and wherein the N pairs of braces, relative to a vertical central axis of the tower support, are directed radially outwards from the tower support in different directions about the vertical central axis;
wherein the method comprises at least one of A, B and C:
(A) the tower support constitutes the first tubular member and has welded to it the shell-unit, the first brace constitutes the second tubular member, the second end-part of the first brace constitutes the end-part of the second tubular member; and the method comprises inserting the second end-part of the first brace in the cavity of the shell-unit and fixing it therein with the casting material to form the first rigid connection;
(B) the tower support constitutes the first tubular member and has welded to it the shell-unit, the second brace constitutes the second tubular member, the second end-part of the second brace constitutes the end-part of the second tubular member, and the method comprises inserting the second end-part of the second brace in the cavity of the shell-unit and fixing it therein with the casting material to form the second rigid connection;
(C) the first brace constitutes the first tubular member and has welded to it the shell-unit, the second brace constitutes the second tubular member, the first end-part of the second brace constitutes the end-part of the second tubular member, and the method comprises inserting the first end-part of the second brace into the cavity of the shell-unit and fixing it therein with the casting material to form the third rigid connection.

10. The method according to claim 9, further comprising:
providing a third set of N third braces; and
interconnecting the first braces by the third braces for increasing rigidity between the first braces.

11. The method according to claim 10, wherein N is 3 and the third braces form a triangular structure.

12. The method according to claim 11, wherein the triangular structure is a tetrahedral structure formed by the first braces, the second braces and the third braces.

13. The method according to claim 1, further comprising:
assembling the offshore support structure onshore;
providing a wind turbine on top of the support structure;
after assembly, moving the offshore support structure to an offshore point of destination; and
anchoring the offshore support structure to a seabed.

14. The method of claim 13, further comprising:
providing the offshore support structure with buoyancy tanks; and
installing the offshore support structure as a floating structure.

15. An offshore support structure provided by the method according to claim 1.
